(19) United States
(12) Patent Application Publication
(10) Pub. No.: US 2010/0033336 A1
(43) Pub. Date: Feb. 11, 2010

(54) Natural gas alarm

(76) Inventor: Gwendolyn Jones, Chicago, IL (US)

Correspondence Address: Ms. Gwendolyn Jones, P.O. Box 81263, Chicago, IL, 60681, US

(21) Appl. No.: 11/888,595

(22) Filed: Aug. 18, 2008

Related U.S. Application Data
(60) Provisional application No. 60/861,292, filed on Nov. 29, 2006.

(51) Int. Cl. G08B 17/10

(52) U.S. Cl. 340/632

(57) ABSTRACT

A combined natural gas and audible alarm device includes a circular-shaped housing. An internal power supply source is positioned in the housing and includes batteries. Threaded fasteners are supplied for mounting the device onto a support surface. The housing further encloses a natural gas detector, an audible alarm unit, and printed circuit board. A battery status light and a pushbutton switch are externally positioned on the front surface of the housing. The battery status light is illuminated whenever the battery level is low, notifying a person that the battery needs to be replaced. The pushbutton switch is depressed to test operation of the device. As natural gas is lighter than air and rises, the device is either wall or ceiling mounted.

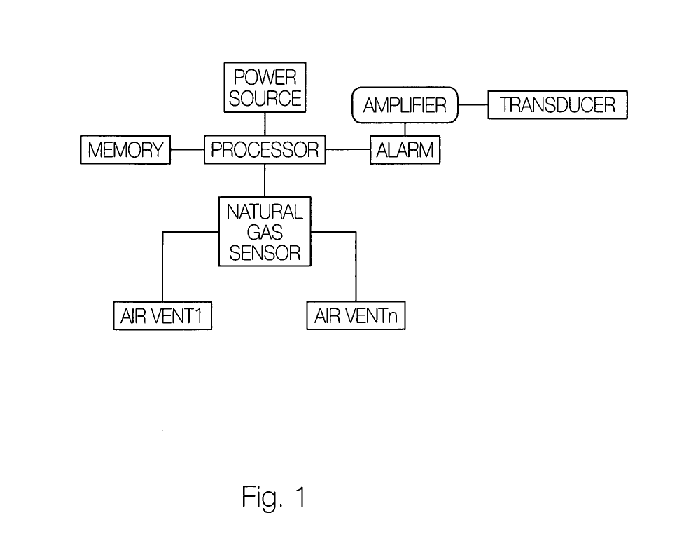

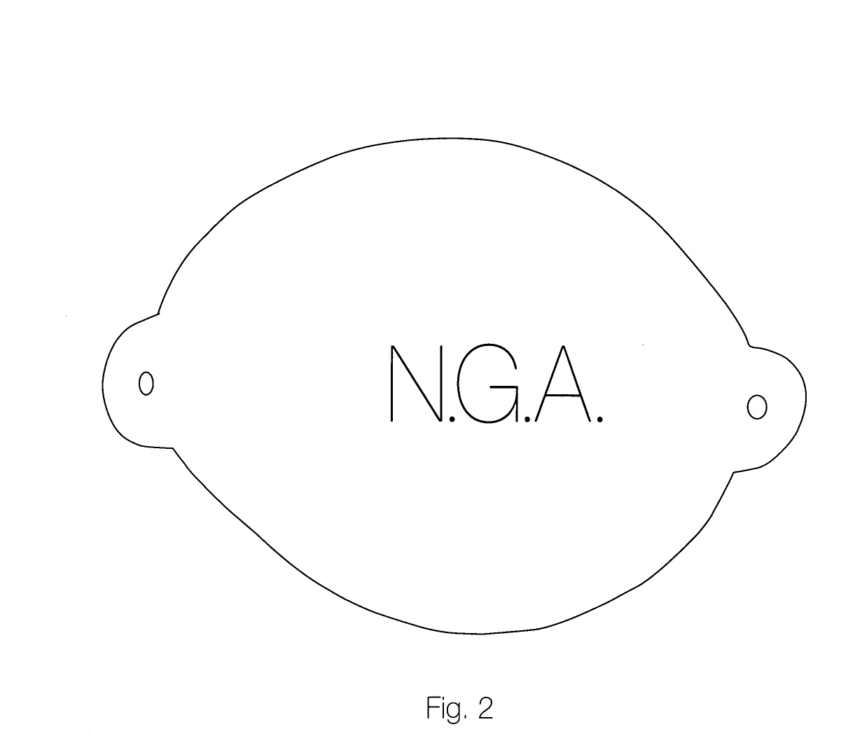

### CROSS REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Technical Field

This invention relates to detection devices and, more particularly, to a combined natural gas and audible alarm device for emitting a vary audible alarm to alert individuals of the danger in a home or other type of building and the need to evacuate and alert the local fire department of the gas leak.

2. Prior Art

Natural gas is a flammable gaseous mixture consisting mostly of hydrocarbons which may contain as much as 85 percent methane, about 10 percent ethane, and also contains smaller amounts of propane, butane, pentane, and other alkanes. Natural gas, which is usually found together with petroleum deposits in the Earth's crust, is extracted and refined into fuels that provide approximately 25 percent of the world energy supply. Natural gas is the predominant energy source for home heating in North America and is piped into more than half of all homes. It's also commonly used for cooking, fireplaces and water heating.

Natural gas is lighter than air and will rise if a leak should develop. A natural gas leak in your home could cause. untold devastation in a building explosion. For safety, an odorant, known as Mercaptan, is added to natural gas. The smell detection threshold for humans is about 20 per cent of the lower explosion limit (LEL) of the fuel. However, your ability to sense and respond to a leak may decline with continued exposure, especially during sleep when one is most susceptible. Smoke and carbon monoxide alarms will not alert to this threat and prolonged, high-level exposure can be fatal. Obviously, it would be advantageous to provide a means alerting persons to a natural gas leak.

Accordingly, a need remains for a combined natural gas and audible alarm device in order to overcome the above-noted shortcomings. The present invention satisfies such a need by providing a device that is convenient and easy to use, durable in design, is easily installed, and provides users with an effective means to detect a gas leak in a timely fashion. Such a device advantageously allows a person or persons to alert emergency personnel and the authorities about a gas leak such that preventative measures can be taken to prevent serious damages, injuries, and even deaths. The device is easily mounted onto a variety of support surfaces, thus ensuring that it can be positioned for optimal detection.

### BRIEF DESCRIPTION OF THE SEVERAL VIEWS OF THE DRAWING

The novel features believed to be characteristic of this invention are set forth with particularity in the appended claims. The invention itself, however, both as to its organization and method of operation, together with further objects and advantages thereof, may best be understood by reference to the following description taken in connection with the accompanying drawings in which:

The figures generally include various perspective views and a schematic block diagram showing a combined natural gas and audible alarm device, in accordance with the present invention.

### DETAILED DESCRIPTION OF THE INVENTION

The present invention will now be described more fully hereinafter with reference to the accompanying drawings, in which a preferred embodiment of the invention is shown. This invention may, however, be embodied in many different forms and should not be construed as limited to the embodiment set forth herein. Rather, this embodiment is provided so that this application will be thorough and complete, and will fully convey the true scope of the invention to those skilled in the art.

The device of this invention is referred to generally in the figures and is intended to provide a combined natural gas and audible alarm device. It should be understood that the device may be used to detect many different types of gaseous leaks and should not be limited in use to only detecting natural gas leaks.

Referring to the figures in general, the device includes a compact circular-shaped housing. Of course, the housing may be produced in a variety of alternate shapes and sizes, as is obvious to a person of ordinary skill in the art. An internal power supply source is positioned in the housing and includes batteries required for proper operation of the device. A plurality of threaded fasteners are supplied with the device for conveniently mounting same onto a support surface. The outer housing is produced from sturdy plastic material and encloses a natural gas detector, an audible alarm unit, printed circuit board, and a pair of replaceable batteries, mentioned herein above. A battery status light and a pushbutton switch are externally positioned on the front surface of the housing.

Still referring to the figures in general, the battery status light is effectively illuminated whenever the battery level is low, which is crucial for notifying a person that the battery needs to be replaced. The pushbutton switch can be depressed to conveniently and effectively test operation of the device. As natural gas is lighter than air and rises, the device is either mounted onto wall or a ceiling. Of course, the device could be used in conjunction with various types of devices/equipment, like space heaters, gas fireplace, and ranges, which use natural gas as a fuel and should be installed in an area that is near the device and the natural gas supply line, as is obvious to a person of ordinary skill in the art. Should a leak develop, the placement of the device is crucial as the time between detection and emitting the alarm to alert residents/individuals is critical. The device is designed to emit an alarm before concentrations reach 25 percent of the lower explosion limit (LEL) to warn you well before an explosion becomes imminent. In the event that natural gas fumes in the sampled air reach that level, the emitted alarm is very loud to ensure everyone is fully awake and aware of the danger and provides more than ample time to evacuate the area. The device can beneficially be used by anyone that uses any type of device or equipment that is fueled by natural gas.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

It is noted the purpose of the foregoing abstract is to enable the U.S. Patent and Trademark Office and the public generally, especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

While the invention has been described with respect to certain specific embodiments, it will be appreciated that many modifications and changes may be made by those skilled in the art without departing from the spirit of the invention. It is intended, therefore, by the appended claims to cover all such modifications and changes as fall within the true spirit and scope of the invention.

In particular, with respect to the above description, it is to be realized that the optimum dimensional relationships for the parts of the present invention may include variations in size, materials, shape, form, function and manner of operation. The assembly and use of the present invention are deemed readily apparent and obvious to one skilled in the art.

What is claimed as new and what is desired to secure by Letters Patent of the United States is:

1. A combined natural gas and audible alarm device for emitting a vary audible alarm to alert individuals of the danger in a home or other type of building and the need to evacuate and alert the local fire department of the gas leak.
